(19) United States
(12) Patent Application Publication
(10) Pub. No.: US 2022/0160159 A1
(43) Pub. Date: May 26, 2022

(54) FOOD PROCESSING APPARATUS AND PORTIONS THEREOF

(71) Applicant: IP OF AUSTRALASIAN DISTRIBUTORS PTY LTD, CAMPBELLFIELD, VICTORIA (AU)

(72) Inventor: Julian Righetti, Campbellfield, Victoria (AU)

(21) Appl. No.: 17/593,497

(22) PCT Filed: Mar. 20, 2020
(86) PCT No.: PCT/AU2020/050265

§ 371 Date: Sep. 20, 2021

(30) Foreign Application Priority Data
Mar. 21, 2019 (AU) 2019900957

(51) Int. Cl. A47J 19/02; A47J 19/06; A23N 1/00; B30B 9/12; B30B 9/14

(52) U.S. Cl. CPC A47J 19/025; A47J 19/06; B30B 9/14; B30B 9/128; A23N 1/00

(57) ABSTRACT

Appliances useful in extracting a liquid from plant material in the preparation beverages and other food products in the home. An appliance may be embodied in the form of a food processing apparatus having a lid with an entry space formed therein, a rotatable element, and one or more food material contacting surfaces surrounding the rotatable element and disposed below the entry space of the lid. The rotatable element and the one or more food material contacting surfaces are each configured and mutually spatially arranged such that in use a food material disposed about the rotatable element is forced against the one or more food material contacting surfaces. Accordingly, the food material is deformed or divided and is caused or allowed to clear the one or more food material contacting surfaces.

### FIELD OF THE INVENTION

The present invention relates generally to domestic appliances useful in extracting a liquid from plant material including but not limited to a fruit, a berry, a vegetable, a leaf, a stalk, or a nut. Such appliances are typically used by consumers to freshly prepare healthy beverages in the home. In addition or alternatively, the invention may be used to prepare sorbets and similar food products.

### BACKGROUND TO THE INVENTION

So-called “cold press” juicing apparatus are known in the art, with many forms being available to the consumer at the filing date of this application. Typically, the apparatus is in the form of a small home appliance suitable for use on a counter-top. The appliance generally comprises an electrically powered motor which provides the mechanical force required to break up the source plant material and press the juice therefrom.

Typically, the motor rotates a screw-like structure disposed within a filter basket of some type. The source plant material is disposed within the basket by some means, and the rotating screw functions to direct the material generally downwardly and outwardly toward the filter basket wall. Generally the rotating screw-like structure widens toward the base (and/or the basket narrows about the base of the screw) such that the source material is pressed forcefully against the filter basket wall. The force acts to disrupt plant structures and also the cells forming those structures so as to liberate a nutritious juice. The juice is typically caught in vessel of some type which channels the liquid to an outlet for collection in a drinking glass.

The filter basket retains the solid material left behind after the juice is extracted. Many juicing apparatus comprise means for continually removing the solid material such that it becomes unnecessary for the user to intermittently halt the juicing process to manually remove the material.

It is also known in the art for some juicing apparatus to include means for pre-processing the source plant material in preparation for the final step of pressing juice from the plant material. For example, some apparatus have a crushing space integral with the lid. Large pieces of plant material are manually urged through a chute attached to the lid, and when exiting the chute the material is crushed against a specially formed surface on the internal side of the lid. The crushed material is better suited as starting material for the pressing process that is subsequently performed in the underlying filter basket.

A problem presents in that plant material tends to become trapped in such crushing spaces. It not unusual for remnants of crushed plant material to build up in the space during use. This can cause difficulties in feeding new plant source material into the space given the need to firstly expel the built-up material. Material tends to clump in the small crushing space, and does not readily fall downwardly into the filter basket below. The clumped material is exposed to the air for a significant period of time and may oxidize, leading to the formation of an undesirable brownish colouring to the juice formed therefrom. Some food material can only be practically removed during washing, and in that case the material is never consumed and is therefore wasted.

A further problem is that the small crushing space can be difficult to clean. While the lid which forms the crushing space will of course be routinely cleaned after use, special attention is needed to ensure all plant material is removed. A small brush or other implement may be necessary to ensure proper cleaning of the space. The task of cleaning the crushing space can be onerous and generally detract from the consumer's experience with the product.

A small crushing area further limits the surface area available for incoming plant material to be crushed against. This in turn slows that rate at which source plant material may be fed into the apparatus. Thus, a user must spend a longer time to prepare a given volume of juice given the limitation in pre-processing speed brought about by a small crushing space in the lid.

Some or all of the functional problems described above may arise where the apparatus is used for preparing a non-juice such as a plant-derived milk (for example a nut milk), or a food product such as a sorbet. In these applications, the apparatus nevertheless functions to break up incoming food material and force it against a filter.

A further problem is that the crushing space in prior art lids forms a significant “hump” on the upper face. This feature is generally undesirable as it detracts from the overall visual appearance of the apparatus. As will be appreciated, a food processing apparatus may remain on the kitchen counter-top when not in use and consumers are conscious of any negative visual impact cause by an exposed appliance that is aesthetically displeasing.

It is an aspect of the present invention to provide an improvement to prior art food processing apparatus so as to provide improved processing of large pieces of food material before the pressing process. It is a further aspect of the prior art to provide a useful alternative to prior art food processing apparatus.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a food processing apparatus portion for deforming a food material or dividing a food material so as to be more useable in a subsequent pressing process, the food processing apparatus portion comprising: a lid having an entry space formed therein, a rotatable element, and one or more food material contacting surfaces surrounding the rotatable element and disposed below the entry space of the lid, wherein the rotatable element and the one or more food material contacting surfaces are each configured and mutually spatially arranged such that in use a food material disposed about the rotatable element is forced against the one or more food material contacting surfaces so as to deform or divide the food material, and the resultant deformed or divided food material is caused or allowed to clear the one or more food material contacting surfaces.

In one embodiment of the first aspect, the rotatable element and the one or more food material contacting surfaces are each configured and mutually spatially arranged such that in use a divided or deformed food material is caused or allowed to drop clear from the one or more food material contacting surfaces under at least the partial influence of gravity.

In one embodiment of the first aspect, the rotatable element and the one or more food material contacting surfaces are each configured and mutually spatially arranged such that in use a food material is caused or allowed to contact the one or more food material contacting surfaces under at least the partial influence of gravity.

In one embodiment of the first aspect, the food processing apparatus portion comprises a food material entry space allowing the generally downward entry of a food material, and a food material exit space allowing the generally downward exit of deformed or divided food material, wherein the food material entry space and the food material exit space are each defined at least in part by the one or more food material contacting surfaces.

In one embodiment of the first aspect, the food material entry space is in or about an upper region of the food processing apparatus portion, and the food material exit space is in or about a lower region of the food processing apparatus.

In one embodiment of the first aspect, the food processing apparatus has an axis passing through the rotatable element, the food material entry space and the food material exit space.

In one embodiment of the first aspect, when present in an assembled food processing apparatus the axis assumes a substantially vertical orientation upon assembly.

In one embodiment of the first aspect, the one or more food material contacting surfaces partially or completely surround at least a portion of the rotatable element.

In one embodiment of the first aspect, one of the one or more food material contacting surfaces faces generally toward the rotatable element.

In one embodiment of the first aspect, one of the one or more food material contacting surfaces is generally concave and faces generally toward the rotatable element.

In one embodiment of the first aspect, the rotatable element and one of the one or more food material contacting surfaces each have an upper region and a lower region, and wherein the distance between the upper region of the one of the one or more food material contacting surfaces and the upper region of the rotatable element is greater than the distance between the lower region of the one of the one or more food material contacting surfaces and the lower region of the rotatable element.

In one embodiment of the first aspect, the one or more food material contacting surfaces are formed at least in part by the inner face of a geometrically regular structure.

In one embodiment of the first aspect, the geometrically regular structure is generally cylindrical or generally frustoconical.

In one embodiment of the first aspect, one of the one or more food material contacting surfaces is provided by a body extending generally toward the rotatable element.

In one embodiment of the first aspect, the food processing apparatus portion comprises two or more food material contacting surfaces, wherein the first of the two or more food material contacting surfaces is a surface facing generally toward the rotatable element, and the second of the two or more food material contacting surfaces is the body extending generally toward the rotatable element.

In one embodiment of the first aspect, the body extending toward the rotatable element is substantially fin-shaped.

In one embodiment of the first aspect, the rotatable element has a longitudinal axis, and the one or more food material contacting surfaces are formed at least in part by the inner face of a geometrically regular structure having an axis, and the axes are coincident or at least mutually parallel.

In one embodiment of the first aspect, the rotatable element has a food material pushing formation extending generally outwardly therefrom.

In one embodiment of the first aspect, the food material pushing formation is configured such that when rotating the rotatable element is rotating a food material is pushed against one of the more or more food material contacting surfaces.

In one embodiment of the first aspect, the rotatable portion is configured such that when rotating the food material pushing formation moves over or generally toward one of the one or more food material contacting surfaces.

In one embodiment of the first aspect, the space between the food material pushing formation and one of the one of more food contacting surfaces is sufficient so as to allow a food material enter in the space, but also to contact the food material pushing formation and the one or more food contacting surfaces in the course of a rotation of the rotatable element.

In one embodiment of the first aspect, the food material pushing portion is disposed at or toward an upper region of the rotatable element.

In one embodiment of the first aspect, the rotatable element has a conveying formation configured to convey or assist in conveying a deformed or divided food material generally downwardly and out of the food processing apparatus portion.

In one embodiment of the first aspect, the conveying formation is generally a screw thread-like.

In one embodiment of the first aspect, the conveying portion is disposed inferior to the food material pushing formation such that a food material is deformed or divided by contact with the food pushing formation and the one or more food material contacting surfaces, and the so formed deformed or divided food material is urged downwardly by the conveying portion so as to eventually exit the food processing apparatus portion.

In one embodiment of the first aspect, the lower region or edge of one of the one or more food material contacting surfaces has associated therewith means to assemble with an underlying catching means of a food processing apparatus.

In one embodiment of the first aspect, the means to assemble with an underlying catching means of a food processing apparatus is configured such that the one of the one or more food contacting surfaces are removable from and attachable to the base of a food processing apparatus by rotating the one of the one or more food material contacting surfaces relative to the underlying catching means, and optionally lifting or lowering the one or more food material contacting surface from or toward the underlying catching means.

In a second aspect, the present invention provides the combination of the food processing apparatus portion of any embodiment of the first aspect, and an underlying catching means, wherein the catching means is configured to receive a deformed or divided food material originating from the food processing apparatus portion.

In one embodiment of the second aspect, the combination comprises means for assembling the food processing apparatus portion and the underlying catching means together.

In one embodiment of the second aspect, the underlying catching means comprises or consists of a juicing basket configured to facilitate the extraction of a liquid from a deformed or divided food material present therein.

In one embodiment of the second aspect, the juicing basket comprises a substantially rigid wall and/or floor having spaces formed therein such that a deformed or divided food material pressed thereagainst is caused to release a liquid extract and the liquid extract exits the juicing basket via the spaces and a remaining solid portion is retained in the basket for at least some time.

In one embodiment of the second aspect, the catching means comprises a vessel, and the juicing basket is within the vessel such that a liquid extract passing through the spaces of the juicing basket is caught by the vessel.

In one embodiment of the second aspect, the vessel or the juicing basket comprises means for assembly with the food processing apparatus portion.

In one embodiment of the second aspect, the rotatable element extends downwardly into the juicing basket and the region of the rotatable element within the juicing basket is configured to press a deformed or divided food material against the wall or the floor of the juicing basket.

In a third aspect, the present invention provides a food processing apparatus comprising the combination of any embodiment of the second aspect.

In one embodiment of the third aspect, the food processing apparatus further comprising a motor configured to rotate the rotatable element.

### BRIEF DESCRIPTION OF THE FIGURES

FIG. 1A illustrates a perspective plan view of a highly preferred insert of the present invention. The insert provides surfaces against which source food material are compressed.

FIG. 1B illustrates a lateral view of the highly preferred insert shown in FIG. 1A.

FIG. 1C illustrates a bottom view of the highly preferred insert shown in FIG. 1A.

FIG. 2A illustrates a perspective view of a liquid extract catching vessel designed to be disposed underneath and attached to the insert shown in FIG. 1A.

FIG. 3A illustrates a perspective plan view of a highly preferred lid of the present invention. The lid is designed to fit over the insert of FIG. 1A.

FIG. 3B illustrates a lateral view of the highly preferred lid shown in FIG. 3A.

FIG. 3C illustrates a bottom view of the highly preferred insert shown in FIG. 3A.

FIG. 4 is a cross-sectional illustration of an assembled food processing apparatus portion comprising the insert shown in FIG. 1A, liquid extract catching vessel of FIG. 2A and the lid of FIG. 3A. Also represented in a rotating element and a filter basket, these items not being shown separate in the drawings.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the inventor's discovery that advantage (or at least an optional arrangement) is provided where pre-processing of food material is performed in a space below the upper surface of lid and/or below the input chute of a food processing apparatus. This approach represents a significant departure from prior art food processing apparatus that pre-process food material in a recess formed within the lid, and particularly in a recess formed above the main plane of the lid, or a recess lateral to the lid chute.

Moving pre-processing to a space below the lid and/or below the chute allows for a larger space and larger surfaces to be dedicated to pre-processing incoming food material. Thus, rather than incoming material being diverted laterally from a feed chute into a necessarily small crushing space formed over the surface of the lid (as in the prior art), the present invention allows food material to drop directly downward from the chute and into a space below the upper surface of the lid, and below the chute.

The present provides that deformation (such as bending and crushing) of food material, or dividing the material into smaller fragments can occur in a space below the lid and/or chute, with specific embodiments being described below.

In one embodiment, the invention is directed to a food processing apparatus portion, such portion being useful as a part of a complete functional apparatus. In a broad form, the food processing apparatus portion comprises a lid, a rotatable element, and one or more food material contacting surfaces. As will be understood such a portion may not of itself be capable of functioning as a food processing apparatus, and typically will require further components such as an electric motor, electrical power cord and the like to be properly operable. Such further componentry and means for incorporation into a food processing apparatus are well known to the skilled artisan who will be enabled to construct an operable apparatus according to the present invention having the full benefit of the present specification.

In the present food processing apparatus portion, the lid is generally configured so as to prevent undesired egress of food material during operation. The lid also provides a means for admitting source plane material into the apparatus, and to that extent has an entry space formed therein. The entry space is typically an aperture formed in the main planar region of the lid, however the space may be defined by lid and non-lid parts of the food processing apparatus portion, or indeed the lid and any other part of a the food processing apparatus as a whole. The lid may comprise a chute or a guide of some type to assist in directing input food material through the entry space. An elongate chute is most often incorporated into the lid, extending upwardly at an angle therefrom, with the user manually pushing food material therethrough (often with the assistance of a plunger-like member), the food material then passing into a space below the lid.

In the present invention, the space below the upper surface of the lid or below the chute comprises one or more food material contacting surfaces. These surface(s) are oriented such that food material which passes through the entry space in the lid impacts thereon. The contact may arise from the natural downward movement of the food material through the entry space, or may be caused or at least assisted by the rotation of the rotatable element in the course of its rotation.

The food material contacting surface(s) are formed from a material that is sufficiently rigid so as to allow food material (such as the flesh of a fruit or the body of a vegetable) to be urged thereagainst with a force sufficient to deform or divide the material, but without itself materially deforming. Thus a firm surface is provided against which food material may be crushed, bent, divided, pulverised, or deformed in any other way.

As will be understood, the aim of the deformation or division of an incoming piece of food material may be to decrease the overall size of the piece so as to facilitate a later step of pressing liquid extract therefrom. Many food processors press liquid extract from food materials by pressing material against the wall of a filter basket or similar contrivance. This pressing is often achieved by forcing the food material into a small space, one side of the space being the filter basket wall. Large untreated chunks of food material are not physically able to enter a small space, and are therefore not able to give up juice or other liquid extract. Decreasing the overall size of the food material or deforming it to make softer or more flexible increases the ability of the material to enter the small spaces adjacent to the filter basket wall.

Where required, the rotatable element may assist in moving processed food material downwardly and into the small spaces adjacent the filter basket wall. For example, the rotatable element may be screw-like with the thread acting to propel material downwards (in a manner similar to Archimedes' screw) and to the lower regions of the basket where most compression occurs.

Having the benefit of the present specification, the skilled artisan is able to arrive at arrangements alternative to those explicitly disclosed herein whereby food material contacting surfaces are disposed below the upper surface of the lid, or below the chute of the lid. The contacting surfaces will typically be stationary, and should be arranged so as to avoid being struck by the rotatable element when rotating.

The food material contacting surface(s) may be planar, undulating, curved, or any other geometry. In any event, for ease of cleaning a generally smooth surface is preferred.

The food material contacting surface(s) may mostly surround, and optionally completely surround the rotatable element to provide a continuous surface about and facing toward the rotatable element. In this way, maximal surface area is provided against which food material may be compressed, and throughput of the apparatus is maximized. A continuous surface may be provided by the insert surface of sleeve-type structure. The rotatable element may be disposed within the sleeve-like structure, and is optionally generally coaxial therewith. In cross-section the sleeve may be circular, ovoid, polygonal (having 3, 4, 5, 6, 8, 9, 10, 11, 12 or more sides), or star shaped for example. In some embodiments, the walls of the sleeve are bent inwards toward the rotatable element. The sleeve may be cross-sectionally identical along its length in terms of shape and/or size. In other embodiments, the cross-section shape and or size varies along the sleeve length. In a highly preferred embodiment, the sleeve narrows toward its lower edge.

In operation, and where the rotatable element is rotating, the rotatable element acts to push incoming food material against the internal faces of the sleeve, thereby compressing the material. As detailed more fully below, the rotatable element may be configured to, upon rotation, decrease a gap between the food material contacting surface and the rotatable element thereby compressing any material present in the gap. For example, the rotatable element have an asymmetry, eccentricity, or formation which decreases the gap in the course of rotation.

In some embodiments of the invention, one of the one or more plant contacting surfaces is provided by a contacting surface body. The body (as distinct from the contacting surface provided by the body) may be orientated generally toward the rotatable element. For example the body may be aligned radially in a manner similar to the spokes of a wheel, whereby the body extends from a peripheral structure toward the centre of the rotatable element.

The contacting surface body may provide a broad food material contacting surface that is not directed toward the rotatable element. Considering a radially aligned fin-like contacting surface body, a broad contacting surface (being a face of the fin-like structure) is presented orthogonal to the radial line. In these embodiments, the rotating element may push incoming food material against the orthogonally presented contacting surface. Where the contacting surface body is sufficient resistant to deformation, the contacting surface provides a stable surface against which food material may be crushed.

Alternatively, the rotating element may shear the food material against an edge of the contacting surface body. The shearing forces may result is the material being stretched, weakened, bent or even severed.

An edge of the contacting surface directed toward the rotatable element may provide a very narrow food material contacting surface (as distinct from a shearing edge), with material caught between the rotatable element and the edge being compressed against the edge contacting surface. In this embodiment, in the course of rotation the rotatable element compresses the food material presses against the edge contacting surface.

There may be provided 1, 2, 3, 4, 5, 6, 7, 8, 9, 10 or more contacting surface bodies, although preferably 3, 4, or 5 are provided. It is preferable for a minimum space to remain between adjacent contact surface bodies to allow food material portions to enter the space therebetween. Food material in the between spaces is able to be compressed against a broad face of the body, or indeed another contacting surface such as a surface from which the body extends.

The peripheral structure from which the body extends may be a curved surface, the curved surface in itself providing a further food material contacting surface.

As will be appreciated from the above, one function of the rotatable element is to push incoming food material against the food material contacting surface(s). In operation, the rotatable element and the food material contacting surfaces are mutually spaced such that at one, some or all stages of rotation a space exists between an edge of the rotatable element and the food material contacting surface(s). The space is sufficiently large so as to allow a portion of food material to become sandwiched between the rotatable element and a proximal food material contact surface. The space may narrow in the course of a rotation (due to the shape of the rotatable element or an eccentric mounting thereof) the narrowing causing the trapped material to be compressed. The aim is for the sandwiching and/or compression to cause deformation and in some circumstances even division of the food material into separate fragments. In this way, the food material is processed into a form better suited as starting material for the subsequent step of liquid extraction.

The rotatable element is typically elongate, and configured to extend upright and vertically through the filter basket, as in prior art apparatus. However, different to the prior art the rotatable element of the present apparatus is not required to extend over the upper surface of the lid and into a concave recess extending upwardly from the lid. Instead, the present invention allows for the rotatable element to terminate below the upper surface of the lid.

The rotatable element and may have any cross-sectional shape. In some embodiments, the rotatable element has a cylindrical core region with the outer regions having one or more formations which act to contact and push incoming food material against a food material contact surface. In such a circumstance, the outer region may be considered a food material pushing formation. The formation may be a solid body, or a thinner blade-like structure. In any event the formation is sufficient rigid so as to sufficiently compress food material against the plant contact surface(s). In operation, the rotation of the rotatable member causes the food material pushing formation to move through the space beneath the lid of the apparatus portion in a manner similar to the hand of a clock. In its travels, the food material pushing formation catches on a surface of incoming food material and pushes it against a proximal food material contacting surface so as to deform or divide the material.

Once the food material has been deformed or severed, it moves downwardly so as to be pressed to form a juice. Such movement may be due at least in part to the force of gravity, the weight of overlying material, or by mechanical assistance from the rotating element.

The present invention will be now more fully described by reference to the non-limiting drawings provided herewith. In the drawings, the same numeral is used for the same or equivalent structures.

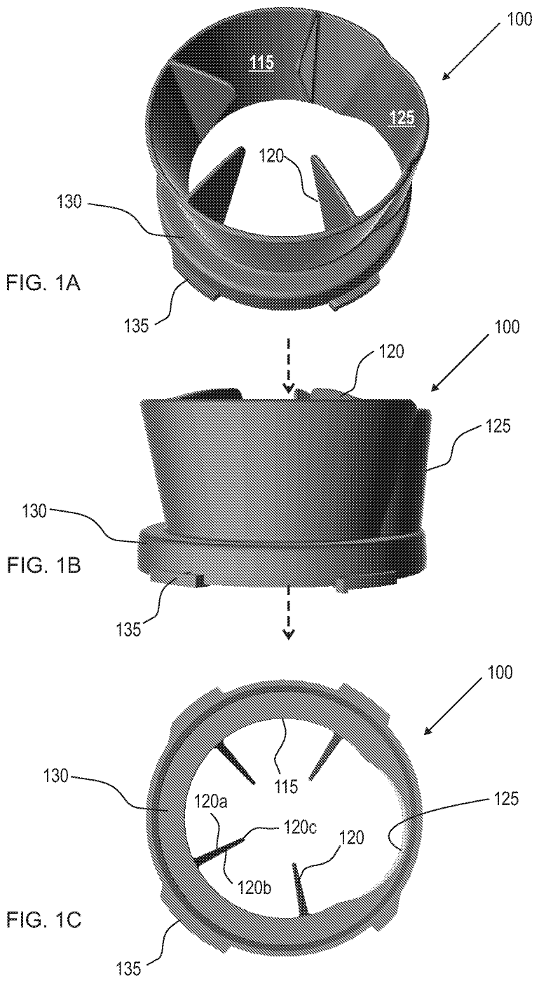

Turning firstly to FIG. 1 there is shown an insert (100) which is a component of the food processing apparatus portion of the present invention which provides food material contacting surfaces against which incoming food material is crushed. The insert is typically fabricated from a plastic which will generally be food grade and may be dishwasher safe. In this embodiment this insert (100) is generally sleeve-like and is removable for cleaning.

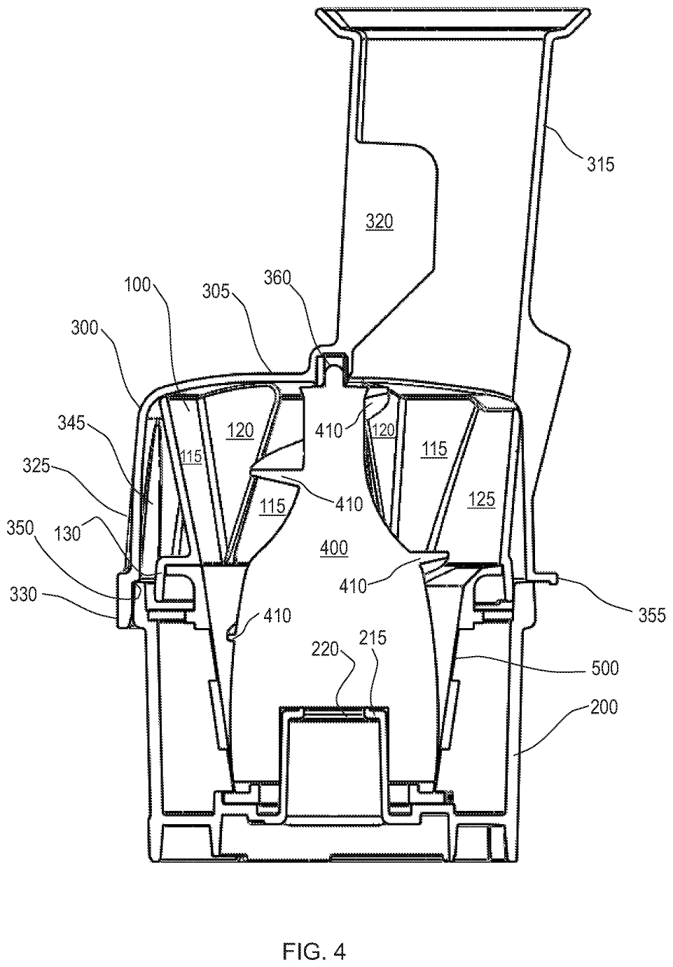

The insert (100) comprises two types of food material contacting surfaces. The first type is provided by the body of the insert (100), being the inside curved surfaces (one marked (115)), and the second type is provided the fin-like structures (one marked (120)) which extend from the curved surfaces (115). Each of the fin-like structure provides two planar surfaces (120a) (120b) and an edge surface (120c). While this embodiment is drawn with 4 fin-like structures, other embodiments may have any number (such as 0, 1, 2, 3, 4, 5 or more. Where no such structures are provided, some reconfiguration will typically be required given that these structure contribute to crushing of the food material. For example, the space between the insert (100) inner face and the thread-like structures (410; as shown in FIG. 4) may be narrowed by moving the insert (100) inner face toward the thread-like structures (410) and/or extending the thread-like structures (410).

It will be noted that the insert (100) tapers toward the base, thereby providing a more open entry space for larger pieces of food material at the upper end, but a more restricted space at the lower end to funnel crushed food material (not shown) toward the underlying filter basket (not shown in this drawing, but marked (500) in FIG. 4). The direction of passage of food material through the insert is indicated by the dashed lines.

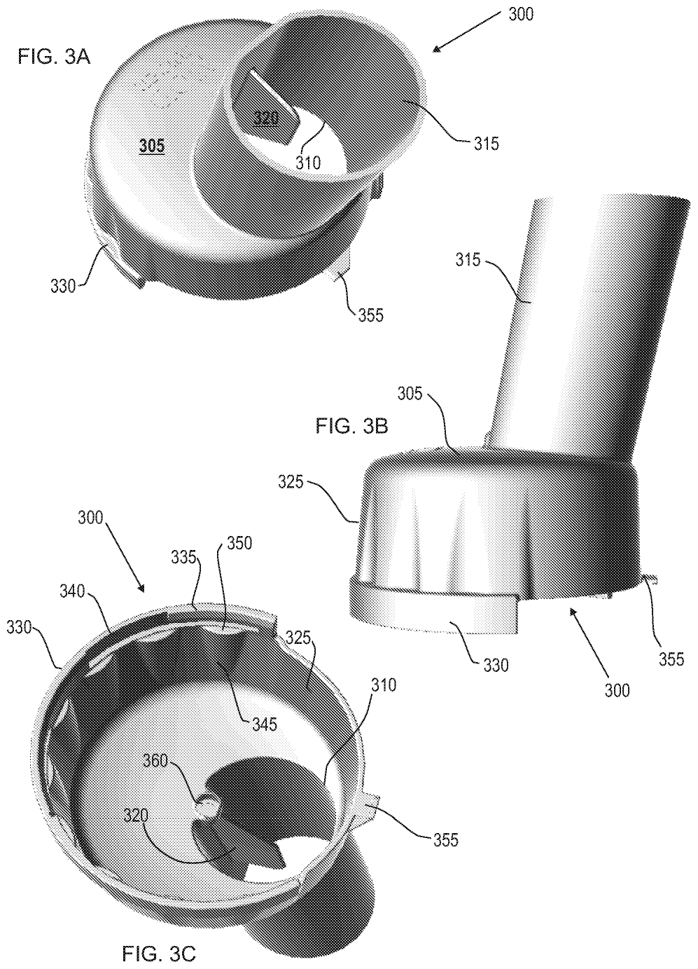

A bulged region (125) is provided in the insert (100). This region defines the space into which source food material initial enters the insert (100), and is immediately below entry an aperture in the lid (not shown in this drawing, but drawn in FIGS. 3A, 3B and 3C). To an extent, the bulged region (125) is somewhat continuous with a portion of the chute wall (not shown, but marked (315) in FIG. 3). In that regard, food material passes along the chute wall and continues into the insert (100) by first contacting the wall of the bulged region (125). Given the angle of the wall of the bulged region (125) food material is directed general toward the rotating element (not shown, but marked (400) in FIG. 4) and toward the fin-like structures (120).

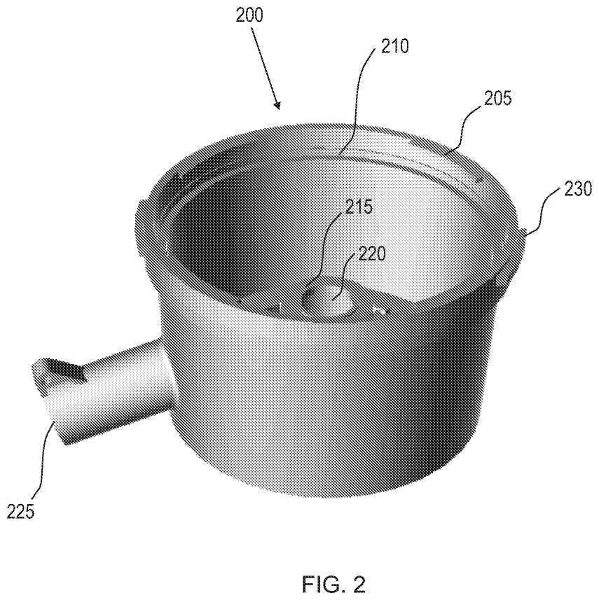

The insert (100) further comprises an annular flange (130) having a series of outwardly directed lugs (one marked (135)) extending therefrom. The flange (130) and lugs (135) facilitate assembly with a liquid extract catching vessel (not shown, but drawn in FIG. 2) disposed beneath.

Reference is now made to FIG. 2 which shows a liquid extract catching vessel (200) which in an assembled food processing apparatus is disposed underneath and reversibly fixed to the insert (100). The upper rim of the liquid extract catching vessel (200) has a series of inwardly directed lugs (205). An annular ledge (210) running around the inside of the vessel (200) and just below the rim is further provided. The lugs (205) and ledge (210) are operable with the lugs (135) and flange (130) of the insert (100) to form a bayonet-type fitting between the parts (100) and (200).

To assemble the insert (100) with the vessel (200), the insert (100) is suspended over the vessel (200) such that the outwardly directed lugs (135) of the insert (100) are out of register with the inwardly directed lugs (205) of the vessel (200). The insert (100) is lowered until the bottom edge of its annular flange (130) rests on the annular ledge (210) of the vessel (200). The insert (200) is then rotated until the lugs (135) and (205) are at least partially in register thereby preventing separation of the parts (100) and (200).

The liquid extract catching vessel (200) comprises a support structure (215) which retains a bearing (not shown) in the aperture (215). The bearing supports and allows rotation of a rotating element (not shown in this drawing, but marked (400) in FIG. 4). The support structure (215) also supports a filter basket (not shown in this drawing but marked (400) in FIG. 4) which locates on the surface about the aperture (220).

The function of the vessel (200) is to catch liquid extract pressed from the food material that passes from a filter basket. The floor (not shown) of the vessel (200) is configured to channel liquid extract (not shown) toward the outlet conduit (225), which typically flows into a drinking glass or a jug (not shown) ready for consumption.

The liquid extract catching vessel (200) comprises a second series of lugs (one marked (230)) which extend outwardly just under the vessel rim. These lugs (230) are configured to fit with complimentary structures on the lid (not shown in this drawing, but drawn in FIGS. 3A, 3B and 3C).

Reference is now made to FIG. 3 which shows a lid (300) of the present invention. As will be initially noted, the lid is devoid of any surface dedicated to the crushing of incoming food material. In prior art lids, a distinct hump rises from the upper surface (305) of the lid (300), the hump creating a concave surface on the underside thereof. In the present invention, the surfaces upon which food material is crushed are provided on a separate structure (the insert (100)) which is disposed below the upper surface (305) of the lid (300).

The lid (300) has an entry aperture (the edge of which is marked (310)) allowing for the passage of incoming food material (not shown). Food material is fed manually into the chute (315) and where of sufficient size is cut by the blade (320) as it is pushed through the chute.

The lid (300) has a vertical portion (325) of significant height. This height is necessary given that the insert (100) is accommodated under the main upper surface (305). A flange (330) extends from part of the vertical section (325), which locates over the upper region of the vessel (200) when assembled. The edge of the flange (330) comprises alternating solid (335) and space (340) regions which force the correct location of the lid (300) given that each lug (230) of the vessel (200) must sit in a space region (340). The formations (one marked (345)) each have a planar surface (350) which sit on the rim of the liquid extract catching vessel (200). The lid (300) is secured to the vessel (200) by the clip (355) which snaps into a recess (not shown) in the outer wall of the vessel (200).

The lid (300) further provides a recess (360) which retains the upper end of a rotatable element (not shown in this drawing, but marked (400) in FIG. 4). The recess (360) allows the rotatable element to rotate, but at the same times prevents it from slipping from its usual vertical orientation.

Reference is made to FIG. 4 which shows the assembly of the insert (100), the liquid extract catching vessel (200) and the lid (300). Also shown in this drawing is the rotating element (400) and the filter basket (500).

The rotating element (400) in this exemplary embodiment is of solid unitary construction, and as will be noted is roughly bottle-shaped having a slim upper neck region and a lower more squat region. A helical thread-like structure (410) winds about the rotating element (400) from top to bottom. The thread-like structure extends outward to a larger degree in the upper regions, and to a lesser degree in the lower regions. In the upper regions of the rotating element (400) the relatively slim neck area allows for the admission of relatively large pieces of food material being pushed down the chute (315) and into the internal space of the insert (100). Once food material is within the internal space of the insert (100) the thread-like structures contact the material and push it against the curved surfaces (115), and also the broad faces (120a) (120b) and edge faces (120c) of the fin-like structures (120).

As will be appreciated from FIG. 4 the surfaces (115) and (120) provide a large total surface area against which incoming food material may be compressed. The surface area is significantly larger than that provided by prior art food processing apparatus that provide a crushing surface above the upper face of the lid, in a concave surface disposed adjacent the chute.

Furthermore, a large space is provided within the insert (100) which is capable of admitting large amounts of food material. The space may be substantially or almost as wide as the lid surface above it. Again, prior art food processing apparatus are deficient in this regards having relatively small crushing spaces to admit material. As will be appreciated, the chute in food processing apparatus is necessarily relatively large, thereby constraining to some extent the size of any concave crushing region formed in the lid, as in the prior art. The present invention allows for a large chute, however because the food material contacting surfaces (which assist in crushing the material) are below the lid top (and therefore below the chute) the chute does not limit the space available for providing crushing surfaces in the apparatus. The large surface area provided by the present apparatus for crushing incoming food material allows the user to more quickly process large amounts of food material, and therefore provide a reasonable amount of liquid extract in a shorter time.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described and/or illustrated herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The terminology used herein is for the purpose of describing particular example embodiments only and is not intended to be limiting. As used herein, the singular forms “a,” “an,” and “the” may be intended to include the plural forms as well, unless the context clearly indicates otherwise.

operations, elements, and/or components, but do not preclude the presence or addition of one or more other features, integers, steps, operations, elements, components, and/or groups thereof.

When an element or layer is referred to as being “on,” “engaged to,” “connected to,” or “coupled to” (or generally equivalent terms), another element or layer it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “lateral”, “side” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention.

Accordingly, the spirit and scope of the present invention is not to be limited by the foregoing examples, but is to be understood in the broadest sense allowable by law.

1. A food processing apparatus portion for deforming a food material or dividing a food material so as to be more useable in a subsequent pressing process, the food processing apparatus portion comprising:
a lid having an entry space formed therein,
a rotatable element, and
one or more food material contacting surfaces surrounding the rotatable element and disposed below the entry space of the lid,
wherein the rotatable element and the one or more food material contacting surfaces are each configured and mutually spatially arranged such that in use a food material disposed about the rotatable element is forced against the one or more food material contacting surfaces so as to deform or divide the food material, and the resultant deformed or divided food material is caused or allowed to clear the one or more food material contacting surfaces.

2. The food processing apparatus portion of claim 1, wherein the rotatable element and the one or more food material contacting surfaces are each configured and mutually spatially arranged such that in use a divided or deformed food material is caused or allowed to drop clear from the one or more food material contacting surfaces under at least the partial influence of gravity.

3. The food processing apparatus portion of claim 1, wherein the rotatable element and the one or more food material contacting surfaces are each configured and mutually spatially arranged such that in use a food material is caused or allowed to contact the one or more food material contacting surfaces under at least the partial influence of gravity.

4. The food processing apparatus portion of claim 1, comprising a food material entry space allowing the generally downward entry of a food material, and a food material exit space allowing the generally downward exit of deformed or divided food material, wherein the food material entry space and the food material exit space are each defined at least in part by the one or more food material contacting surfaces.

5. The food processing apparatus portion of claim 4, wherein the food material entry space is in or about an upper region of the food processing apparatus portion, and the food material exit space is in or about a lower region of the food processing apparatus.

6. (canceled)

7. (canceled)

8. The food processing apparatus portion of claim 1, wherein the one or more food material contacting surfaces partially or completely surround at least a portion of the rotatable element.

9. The food processing apparatus portion of claim 1, wherein at least one of the one or more food material contacting surfaces is generally concave and faces generally toward the rotatable element.

10. (canceled)

11. The food processing apparatus portion of claim 1, wherein the rotatable element and at least one of the one or more food material contacting surfaces each have an upper region and a lower region, and wherein the distance between the upper region of the at least one of the one or more food material contacting surfaces and the upper region of the rotatable element is greater than the distance between the lower region of the at least one of the one or more food material contacting surfaces and the lower region of the rotatable element.

12. (canceled)

13. (canceled)

14. The food processing apparatus portion of claim 1, wherein at least one of the one or more food material contacting surfaces is provided by a body extending generally toward the rotatable element.

15. The food processing apparatus portion of claim 14, comprising two or more food material contacting surfaces, wherein the first of the two or more food material contacting surfaces is a surface facing generally toward the rotatable element, and the second of the two or more food material contacting surfaces is the body extending generally toward the rotatable element.

16. The food processing apparatus portion of claim 14, wherein the body extending toward the rotatable element is substantially fin-shaped.

17. (canceled)

18. The food processing apparatus portion of claim 1, wherein the rotatable element has a food material pushing formation extending generally outwardly therefrom and configured such that when rotating the rotatable element is rotating a food material is pushed against at least one of the more or more food material contacting surfaces.

19. The food processing apparatus portion of claim 1, wherein the rotatable element has a food material pushing formation extending generally outwardly therefrom and configured such that when rotating the rotatable element is rotating a food material is pushed against at least one of the more or more food material contacting surfaces and/or the food material pushing formation moves over or generally toward at least one of the one or more food material contacting surfaces.

20. (canceled)

21. The food processing apparatus portion of claim 19, wherein a space between the food material pushing formation and at least one of the one of more food contacting surfaces is sufficient so as to allow a food material enter in the space, but also to contact the food material pushing formation and the one or more food contacting surfaces in the course of a rotation of the rotatable element.

22. The food processing apparatus portion of claim 19, wherein the food material pushing portion is disposed at or toward an upper region of the rotatable element.

23. The food processing apparatus portion of claim 1, wherein the rotatable element has a screw-like thread configured to convey or assist in conveying a deformed or divided food material generally downwardly and out of the food processing apparatus portion.

24. (canceled)

25. The food processing apparatus portion of claim 23, wherein the screw-like thread is disposed inferior to the food material pushing formation such that a food material is deformed or divided by contact with the food pushing formation and the one or more food material contacting surfaces, and the so formed deformed or divided food material is urged downwardly by the conveying portion so as to eventually exit the food processing apparatus portion.

26. (canceled)

27. (canceled)

28. A combination of:
a food processing apparatus portion for deforming a food material or dividing a food material so as to be more useable in a subsequent pressing process, the food processing apparatus portion comprising:
a lid having an entry space formed therein,
a rotatable element, and
one or more food material contacting surfaces surrounding the rotatable element and disposed below the entry space of the lid,
wherein the rotatable element and the one or more food material contacting surfaces are each configured and mutually spatially arranged such that in use a food material disposed about the rotatable element is forced against the one or more food material contacting surfaces so as to deform or divide the food material, and the resultant deformed or divided food material is caused or allowed to clear the one or more food material contacting surfaces; and
an underlying catching vessel, wherein the catching vessel is configured to receive a deformed or divided food material originating from the food processing apparatus portion and to facilitate extraction of a liquid from a deformed or divided food material present therein.

29. (canceled)

30. (canceled)

31. The combination of claim 28, wherein the catching vessel is a juicing basket comprising a substantially rigid wall and/or floor having spaces formed therein such that a deformed or divided food material pressed thereagainst is caused to release a liquid extract and the liquid extract exits the juicing basket via the spaces and a remaining solid portion is retained in the basket for at least some time.

32. (canceled)

33. (canceled)

34. The combination of claim 31, wherein the rotatable element extends downwardly into the juicing basket and the region of the rotatable element within the juicing basket is configured to press a deformed or divided food material against the wall or the floor of the juicing basket.

35. (canceled)

36. (canceled)
